(19) United States
(12) Patent Application Publication
(10) Pub. No.: US 2026/0161143 A1
(43) Pub. Date: Jun. 11, 2026

(54) SYSTEM AND METHOD FOR OPTIMIZATION OF INDUSTRIAL OPERATION BASED ON SIMULATION DATA THEREOF

(71) Applicant: Quantiphi, Inc, Marlborough, MA (US)

(72) Inventors: Dagnachew Birru, Marlborough, MA (US); Anirudh Deodhar, Mumbai (IN); Rishi Yash Parekh, Mumbai (IN); Tanmaya Singhal, Mumbai (IN); Vipul Patel, Mumbai (IN)

(73) Assignee: Quantiphi, Inc, Marlborough, MA (US)

(21) Appl. No.: 18/975,106

(22) Filed: Dec. 10, 2024

(51) Int. Cl. G05B 13/04; G05B 13/02

(52) U.S. Cl. CPC G05B 13/041; G05B 13/029

(57) ABSTRACT

System (100) for optimization of industrial operation, based on simulation data thereof, system comprising processing unit (102) configured to generate simulation data related to industrial operation; generate knowledge graph ontology; generate knowledge graph instance representing simulation data; receive user request to analyze quality of industrial operation, from user device (104) of user; analyze quality of industrial operation; generate response to user request, based on analyzed quality of industrial operation; send response to user device; receive first user input from user device, wherein first user input is indicative of user approval on industrial operation; and when user approval on industrial operation is positive, employ simulation data for implementation of industrial operation; or when user approval on industrial operation is negative, generate updated simulation data, based on analysis of quality of industrial operation, and repeat aforementioned steps for updated simulation data.

### FIELD OF TECHNOLOGY

The present disclosure generally relates to industrial operations. Specifically, the present disclosure relates to a system and a method for optimization of an industrial operation, based on simulation data thereof.

### BACKGROUND

Generally, in complex industrial processes, such as manufacturing facilities and, processing industries coordinating multiple pieces of equipment and scheduling various operations effectively is critical, where said complex industrial processes require precise timing, resource allocation, and coordination to prevent bottlenecks and inefficiencies. Discrete Event Simulation (DES) is a widely used tool for modelling the equipment by simulating the sequence of operations, identifying and analyzing potential inefficiencies in said complex industrial processes. However, the DES generates vast amounts of data, often in multiple formats like tables and JSON files, making the data cumbersome to manage, interpret, and optimize. As the number of operations and equipment increases, so does the complexity of the data, creating significant challenges for those responsible for analyzing and acting on the simulation results.

Existing solutions aim to address the issue of analyzing the vast amount of complex data by using knowledge graphs to represent relationships and dependencies within the DES data. Moreover, tools like Neo4j, Langchain Graph Transformer, and GraphRAG provide automated methods for transforming textual information into a knowledge graph, allowing users to represent interconnected data in a structured format. Additionally, some existing solutions use retrieval-augmented generation (RAG) to facilitate graph-based querying, which can assist users in accessing relevant insights from simulation data. However, the aforementioned existing solutions have certain limitations such as they often rely on generic templates and lack the specificity required for industrial applications. Furthermore, the existing solutions struggle to handle the combination of text and numerical data across multiple files, which is essential in complex simulations.

While some existing solutions support industrial simulation knowledge graphs, these existing solutions are typically simplistic, requiring extensive manual input and domain-specific customization to function adequately. They cannot dynamically adapt to intricate relationships, time-sensitive data, or diverse information sources typical of real-world industrial simulations. As a result, their application is restricted, and they often fail to provide meaningful insights in environments where equipment, operations, and data configurations constantly change.

Therefore, in light of the foregoing discussion, there exists a need to overcome the aforementioned drawbacks.

### BRIEF SUMMARY OF THE DISCLOSURE

The present disclosure provides a system and a method for optimization of an industrial operation, based on simulation data thereof. The present disclosure seeks to provide a solution to the existing problem of high human input required for domain-specific customization of the simulation data in knowledge graphs. The aim of the present disclosure is to provide a solution that overcomes at least partially the problems encountered in the prior art and provide an improved system and method for optimization of an industrial operation with generating knowledge graph ontology and knowledge graph instance which is domain-specific to the industrial operation.

In one aspect, the present disclosure provides a system for optimization of an industrial operation, based on simulation data thereof. The system comprises a processing unit. The processing unit is configured to generate a simulation data related to the industrial operation. Moreover, the processing unit is configured to generate a knowledge graph ontology, based on a domain of the industrial operation, using a knowledge graph ontology builder module. Furthermore, the processing unit is configured to generate a knowledge graph instance representing the simulation data, based on the knowledge graph ontology, using a knowledge graph creation module. Furthermore, the processing unit is configured to receive a user request to analyze a quality of the industrial operation via the simulation data represented in the knowledge graph instance, from a user device of a user communicably coupled to the processing arrangement. Furthermore, the processing unit is configured to analyze the quality of the industrial operation via the simulation data represented in the knowledge graph instance using a simulation assistant. Furthermore, the processing unit is configured to generate a response to the user request, using the simulation assistant, based on the analysis of the quality of the industrial operation. Furthermore, the processing unit is configured to send the response to the user device. Furthermore, the processing unit is configured to receive a first user input from the user device, wherein the first user input is indicative of a user approval on the industrial operation, based on the response. Furthermore, when the user approval on the industrial operation is positive, the processing unit is configured to employ the simulation data for implementation of the industrial operation. Furthermore, when the user approval on the industrial operation is negative, the processing unit is configured to generate an updated simulation data, based on the analysis of the quality of the industrial operation, and repeat steps from generating the knowledge graph instance to receiving the first user input, for the updated simulation data, wherein the quality of the industrial operation is analyzed via the updated simulation data represented in an updated knowledge graph instance using the simulation assistant, based on a comparison of the updated knowledge graph instance representing the updated simulation data with previously stored knowledge graph instances of historical data related to the industrial operation, stored in a database communicably coupled to the processing unit.

Beneficially, the embodiments of the present disclosure provide a simplified, efficient and automated system that efficiently automate, streamline, and enhance the decision-making process in the industrial operation. Moreover, the system through the knowledge graph ontology, tailored to the domain of the industrial operation, provides a structured representation of the simulated data that captures the intricate relationships between operational elements, and allows the simulation data to be easily represented in the knowledge graph instance, transforming complex datasets of the simulation data into an organized, accessible, and interactive model. As a result, the user can efficiently access, query, and interpret the simulation data, improving operational understanding and response times of the user. Furthermore, the simulation assistant's role in analyzing the quality of industrial operation and generating the response ensures that the user has actionable insights for the industrial operation. The cohesive coordination of modules leads to optimized implementations grounded in data-driven insights, reducing the potential for error and ensuring that the implementation of the industrial operation is aligned with the user's requirements.

In another aspect, the present disclosure provides a method for optimization of an industrial operation, based on simulation support thereof. The method comprises generating a simulation data related to the industrial operation. Moreover, the method comprises generating a knowledge graph ontology, based on a domain of the industrial operation, using a knowledge graph ontology builder module. Furthermore, the method comprises generating a knowledge graph instance representing the simulation data, based on the knowledge graph ontology, using a knowledge graph creation module. Furthermore, the method comprises receiving a user request to analyze a quality of the industrial operation via the simulation data represented in the knowledge graph instance, from a user device of a user communicably coupled to the processing arrangement. Furthermore, the method comprises analyzing the quality of the industrial operation via the simulation data represented in the knowledge graph instance using a simulation assistant. Furthermore, the method comprises generating a response to the user request, using the simulation assistant, based on the analysis of the quality of the industrial operation. Furthermore, the method comprises sending the response to the user device. Furthermore, the method comprises receiving a first user input from the user device, wherein the first user input is indicative of a user approval on the industrial operation, based on the response. Furthermore, when the user approval on the industrial operation is positive, the method comprises employ the simulation data for implementation of the industrial operation. Furthermore, when the user approval on the industrial operation is negative, the method comprises generating an updated simulation data, based on the analysis of the quality of the industrial operation, and repeating steps from generating the knowledge graph instance to receiving the first user input, for the updated simulation data, wherein the quality of the industrial operation is analyzed via the updated simulation data represented in an updated knowledge graph instance using the simulation assistant, based on a comparison of the updated knowledge graph instance representing the updated simulation data with previously stored knowledge graph instances of historical data related to the industrial operation, stored in a database.

The method achieves all the advantages and technical effects of the system of the present disclosure.

It has to be noted that all devices, elements, circuitry, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features, and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not too scaled. Wherever possible, like elements have been indicated by identical numbers.

Embodiments of the present disclosure will now be described, by way of example only, with reference to the following diagrams wherein:

FIG. 1 is a block diagram of a system for optimization of an industrial operation, based on simulation data thereof, in accordance with an embodiment of the present disclosure

FIG. 2 is a schematic illustration of an implementation scenario of different modules employed by a processing unit, in accordance with an embodiment; and

FIGS. 3A and 3B collectively are a flowchart for depicting steps of a method for optimization of an industrial operation, based on simulation data thereof, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF THE DISCLOSURE

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

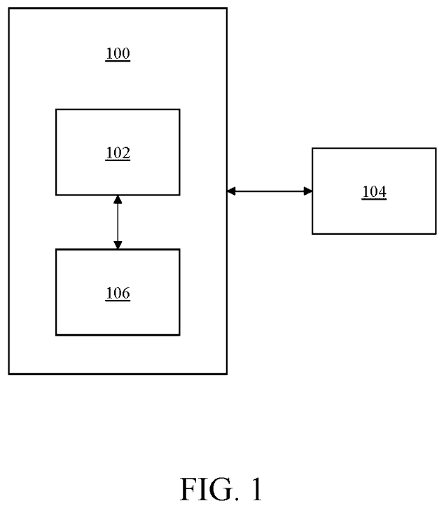

FIG. 1 is a block diagram of a system for optimization of an industrial operation, based on simulation data thereof, in accordance with an embodiment of the present disclosure. The system 100 comprises a processing unit 102.

Herein, the term “processing unit” refers to a computational element that is operable to execute the steps of the system 100. Examples of the processing unit 102 include, but are not limited to, a microprocessor, a microcontroller, a complex instruction set computing (CISC) microprocessor, a reduced instruction set (RISC) microprocessor, a very long instruction word (VLIW) microprocessor, or any other type of processing circuit. Furthermore, the processing unit 102 may refer to one or more individual processors, processing devices and various elements associated with a processing device that may be shared by other processing devices. Additionally, one or more individual processors, processing devices and elements are arranged in various architectures for responding to and processing the instructions that execute the steps of the system 100. Herein, the term “industrial operation” refers to an operational process that involves a multiple decision making steps and complex interplay of different equipments. For example, the industrial operation is one of: a manufacturing operation, a processing industry operation, and the like. Herein, the term “simulation data” refers to data that is generated from running a simulation of the industrial process. Notably, the simulation data is used to gain insights into the working of the industrial operation under different conditions and scenarios.

The processing unit 102 is configured to generate the simulation data related to the industrial operation. Optionally, the simulation data is generated using a Discrete Event Simulation (DES) model. Herein, the term “Discrete Event Simulation (DES) model” refers to a type of mathematical or computational model that is used in simulation of the industrial operation where changes in the industrial operation takes place discretely at different points in time. Notably, the simulation data related to the industrial operation that is generated using the DES model accurately captures the changes in the industrial operation that occurs at discrete moments of time. Optionally, the simulation data is a collection of real-world data as well.

Moreover, the processing unit 102 is configured to generate a knowledge graph ontology, based on a domain of the industrial operation, using a knowledge graph ontology builder module. Herein, the term “knowledge graph ontology” refers to a framework that is used to organize, define and interlink information in any knowledge graph instance meaningfully. In other words, the knowledge graph ontology acts as a skeleton of any knowledge graph instance in which information is added to provide a meaningful structure to that knowledge graph instance. Herein, the term “domain of the industrial operation” refers to a particular technological field to which the industrial operation is related. For example, if the industrial operation is related to a manufacturing shop then the domain of the industrial operation is a discrete manufacturing shop floor (including specific manufacturing operations that take place on that shop floor, the equipment involved, the people involved, the typical sequence of operations). Herein, the term “knowledge graph ontology builder module” refers to a module that enables to create, manage and refine the knowledge graph ontology. In other words, the knowledge graph ontology builder module simplifies the process of defining and organizing entities, relationships, and properties, which collectively form the knowledge graph ontology. Notably, the knowledge graph ontology builder module is an instruction fine-tuned Language Learning Model (LLM) used to generate the knowledge graph ontology, using smart prompts and Retrieval-Augmented Generation (RAG) for accessing the domain of the industrial operation. In an embodiment, the knowledge graph ontology comprises: nodes and relationships of interest of the industrial operation, extracted from the domain of the industrial operation and simulation data. In this regard, the nodes of the industrial operation in the knowledge graph ontology represent the different entities involved in various different processes of the industrial operation. Similarly, the relationships of interest of the industrial operation represent the interdependency and interactions between the nodes of the industrial operation represented in the knowledge graph ontology. Notably, the nodes and the relationships of interest of the industrial application being extracted from the domain of the industrial operation and the simulation data implies that the nodes and the relationships of interest in the knowledge graph ontology are accurately related to the industrial application. A technical effect is that the knowledge graph ontology effectively represents the entities of the industrial operation and the interactions therebetween with respect to the domain of the industrial operation.

In an embodiment, the processing unit 102 is further configured to:
receive a second user input from the user device 104, via a Language Learning Model (LLM) assistant, wherein the second user input is indicative of an efficacy of the knowledge graph ontology that is generated;
compare the efficacy of the knowledge graph ontology with a predefined threshold value; and
when the efficacy of the knowledge graph ontology is lower than the predefined threshold value, modify the knowledge graph ontology, based on a second user input received from the user device 104.

In this regard, the term “efficacy” refers to a parameter that indicates how effective and well-defined the structure of knowledge graph ontology is to represent all the entities (for optimizing the industrial operation) and the relationships between the entities of any industrial operation in any knowledge graph instance. Herein, the term “second user input” refers to an input from the user that enables the user to provide feedback on what is the efficacy of the knowledge graph ontology according to the user. Notably, the efficacy of the knowledge graph ontology is indicated in the second user input in form of a numerical score. Herein, the term “predefined threshold value” refers to a fixed numerical value that acts as a reference value for comparison with the efficacy of the knowledge graph ontology. Subsequently, if the efficacy of the knowledge graph ontology is equal to or greater than the predefined threshold value, then the knowledge graph ontology is deemed to be of acceptable efficacy. Similarly, if the efficacy of the knowledge graph ontology is lower than the predefined threshold value, the knowledge graph ontology is deemed to require improvements for the knowledge graph ontology to be of acceptable efficacy. Subsequently, when the efficacy of the knowledge graph ontology is lower than the predefined threshold value, the knowledge graph ontology is modified to make the knowledge graph ontology of acceptable efficacy. A technical effect is that the user is enabled to effectively provide the feedback on the knowledge graph ontology that is generated to ensure that the knowledge graph ontology is of acceptable level.

Furthermore, the processing unit 102 is configured to generate a knowledge graph instance representing the simulation data, based on the knowledge graph ontology, using a knowledge graph creation module. Herein the term “knowledge graph instance” refers to a data structure that organizes and connects information in a way that enables to understand complex information easily. Subsequently, the knowledge graph instance being used to represent the simulation data related to the industrial operation enables to capture and represent the complex information in the simulation data in a way that is easily understandable by both humans and machines. Optionally, the knowledge graph instance representing the simulation data is converted to an embedding form using an embedding module. Notably, the knowledge graph instance being generated based on the knowledge graph ontology ensures that the knowledge graph instance has a well-defined structure that is easily readable. Herein, the term “knowledge graph creation module” refers to a module that performs the steps required to generate the knowledge graph instance. For example, the knowledge graph creation module is an automated module that reads the simulation data, the generated knowledge graph ontology and creates the knowledge graph instance.

Furthermore, the processing unit 102 is configured to receive a user request to analyze a quality of the industrial operation via the simulation data represented in the knowledge graph instance, from a user device 104 of a user communicably coupled to the processing unit 102. Herein, the term “quality of the industrial operation” refers to a parameter that indicates how effectively and efficiently the industrial operation is performed. Notably, the quality of the industrial operation being analyzed via the simulation data represented in the knowledge graph instance implies that the simulation data represented in the knowledge graph instance is used to determine how effectively and efficiently the industrial operation will perform under the conditions reflected in the simulation data. Herein, the term “user request” refers to a request received from the user via the user device 104 that specifically asks to analyze the quality of the industrial operation via the simulation data represented in the knowledge graph instance. Optionally, the user device 104 is any computing device associated with the user, for example, a mobile phone, a computer, a laptop, a smartwatch, and the like. Moreover, the user device 104 being communicably coupled to the processing unit 102 enables to effectively exchange information between the user device 104 and the processing unit 102. Optionally, the user device 104 is communicably coupled to the processing unit 102 using one of: a Wi-Fi® network, a Bluetooth® network, a cellular network, and the like. Notably, the user request being received from the user enables the processing unit 102 to start the analysis of the quality of the industrial operation in an automated manner.

Furthermore, the processing unit 102 is configured to analyze the quality of the industrial operation via the simulation data represented in the knowledge graph instance using a simulation assistant. Notably, the quality of the industrial operation is analyzed via the simulation data represented in the knowledge graph instance by analyzing the complex information of the simulation data represented in the knowledge graph instance to gain insights about inefficiencies and root causes of the inefficiencies in each step of the industrial operation as indicated in the simulation data related to the industrial operation. Optionally, the analysis of the quality of the industrial operation is concluded by at least one of: a final score about indicating the quality of the industrial operation, a summary of the results from the analysis of the quality of the industrial operation. Herein, the term “simulation assistant” refers to an LLM powered agent that automates the process of analyzing the quality of the industrial operation.

In an embodiment, the analysis of the quality of the industrial operation comprises: inefficiencies in the industrial operation, root cause of the inefficiencies, insights or recommendations based on the inefficiencies and user inputs. In this regard, the term “inefficiencies in the industrial operation” refers to constraints or limitations that are present in any steps or entities of the industrial operation that affects the quality of the industrial operation. Herein, the term “root cause of the inefficiencies” refers to a certain element in the industrial operation that is causing the inefficiencies in the industrial operation. For example, an inefficiency is that some of the orders to be delivered at a specific time are delayed, whereas the root cause of the inefficiency is unavailability of machines or backlog of previously unfulfilled orders. In another example, the inefficiency is that some of the equipment or people are overused or underused, whereas the root cause of the inefficiency is inefficient resource allocation and prioritization. Herein, the insights or recommendations include the steps or adjustments that can be implemented in the industrial operation to improve the quality of the industrial operation. Notably, the insights or recommendations are identified using the identified inefficiencies in the industrial operation, and the user inputs. A technical effect is that the analysis of the quality of the industrial operation includes both the constraints to the quality of the industrial operation and the solutions to improve the quality of the industrial operation.

Furthermore, the processing unit 102 is configured to generate a response to the user request, using the simulation assistant, based on the analysis of the quality of the industrial operation. Herein, the term “response” refers to a reply to the user request that is generated based on the analysis of the quality of the industrial operation. Notably, the response contains the conclusion from the analysis of the quality of the industrial operation. It will be appreciated that the response being generated using the simulation assistant enables the response to be easily interpretable by the user, due to the simulation assistant being the LLM powered agent.

Furthermore, the processing unit 102 is configured to send the response to the user device 104. Notably, the user device 104 being communicably coupled to the processing unit 102 enables the processing unit 102 to send the response to the user device 104. Furthermore, the processing unit 102 is configured to receive a first user input from the user device 104, wherein the first user input is indicative of a user approval on the industrial operation, based on the response. Herein, the term “user approval” refers to a parameter that indicates whether the quality of the industrial operation as indicated from the analysis in the response is up to the standard or requirement of the user or not. Herein, the term “first user input” refers to an input that is received from the user including information about what is the user approval on the industrial operation, based on the response.

Furthermore, when the user approval on the industrial operation is positive, the processing unit 102 is configured to employ the simulation data for implementation of the industrial operation. Notably, the user approval on the industrial operation being positive implies that the quality of the industrial operation is up to the standard or requirement of the user. Subsequently, the simulation data is thus, suitably employed for implementation of the industrial operation to get optimized results from the industrial operation.

Alternatively, when the user approval on the industrial operation is negative, the processing unit 102 is configured to generate an updated simulation data, based on the analysis of the quality of the industrial operation. Notably, the user approval on the industrial operation being negative implies that the quality of the industrial operation is not up to the standard or requirement of the user. Herein, the term “updated simulation data” refers to the a version of the simulation data that is modified in order to make the quality of the industrial operation to meet the standard or requirement of the user. For example, the updated simulation data is generated by modifying the simulation data to increase or decrease a number of resources. Subsequently, the updated simulation data being generated based on the analysis of the quality of the industrial operation implies that the inefficiencies in the industrial operation as determined from the analysis of the quality of the industrial operation are used to determine what changes are to be made in the simulation data to generate the updated simulation data. Notably, the updated simulation data is generated using the simulation assistant. The recommendations approved by the user are implemented as modification in the simulation data to generate the updated simulation data. Subsequently, another knowledge graph instance is generated for representing the updated simulation data.

Furthermore, when the user approval on the industrial operation is negative, the processing unit 102 is configured to repeat steps from generating the knowledge graph instance to receiving the first user input, for the updated simulation data, wherein the quality of the industrial operation is analyzed via the updated simulation data represented in an updated knowledge graph instance using the simulation assistant, based on a comparison of the updated knowledge graph instance representing the updated simulation data with previously stored knowledge graph instances of historical data related to the industrial operation, stored in a database 106 communicably coupled to the processing unit. Notably, repeating the steps from generating the knowledge graph instance to sending the response to the user device, for the updated simulation data enables to receive the first user input that is indicative of the user approval on the industrial operation to be positive, wherein the updated simulation data is employed for the implementation of the industrial operation.

Herein, the term “database” refers to a centralized repository for structured organization of a collection, storage and management of data or information in a way that it may be easily accessed, retrieved, managed, and updated. The database 106 is designed to handle large amounts of data and provide mechanisms for querying, updating, and manipulating that data. Typically, the database 106 organizes the data in the form of tables, columns and the like. Notably, the database 106 may include, but are not limited to, NoSQL database, MySQL, PostgreSQL, document-oriented database such as JSON or BSON, graph databases such as Neo4j, hierarchical database arrangement such as IBM Information Management System (IMS) and the like. Notably, the data stored in the database 106 is of the generated knowledge graph ontology, the generated knowledge graph instances representing the simulation data, the updated knowledge graph instance representing the updated simulation data and the previously stored knowledge graph instances of the historical data related to the industrial operation. Herein, the term “updated knowledge graph instance” refers to a modified version of the generated knowledge graph instance, that is used to represent the updated simulation data. Notably, the updated knowledge graph instance for representing the updated simulation data is generated similarly like the knowledge instance for representing the simulation data. Optionally, the processing unit 102 is communicable coupled with the database 106 through various means such as network connections, application programming interface (APIs), direct data access methods and the like. It will be appreciated that the aforementioned connection allows the system 100 to quickly and efficiently store each updated version of the knowledge graph instances and the knowledge graph ontology as new simulations are generated and analyzed. When the user requests an analysis or approval of any industrial operation, the processing unit 102 can retrieve the knowledge graph instances of the simulation data related to that industrial operation from the database 106, ensuring that analysis and decision-making are based on the historical data as well. Notably, the database 106 enables efficient data retrieval and reduces latency, as the processing unit 102 can access the stored knowledge graph instances immediately, leading to faster response times for the user queries. Additionally, by preserving updated and historical knowledge graph instances, the system 100 can analyze the trends over time, support further optimizations, and apply machine learning or AI algorithms to past data for predictive analytics. It will be appreciated that the processing unit 102 reviews the previously stored knowledge graph instances of the historical data to identify similar simulation results and relevant on-field data in the updated knowledge graph instance representing the updated simulation data. It will be appreciated that the processing unit 102 by comparing the updated knowledge graph instance to past instances, can detect patterns, potential inefficiencies, or improvements, which helps in determining the overall quality and consistency of the industrial operation. For example, the simulation assistant compares the updated knowledge graph instance representing the updated simulation data with the previously stored knowledge graph instances of the historical data on the metric of equipment utilization and suggests reducing or increasing the number of equipment accordingly. The historical comparison is essential for identifying recurring issues and confirming whether the latest operational setup of the industrial operation meets quality expectations based on past data. Moreover, the processing unit 102 access the database 106, to retrieve the historical knowledge graph instances are stored in the database 106 for providing recommendations. The processing unit 102 can use predefined quality metrics or algorithms to highlight differences between the updated simulation data and the historical data, thus facilitating a comprehensive quality assessment. Notably, the comparison capability also reduces manual data review efforts, as the processing unit 102 automates the identification of areas that deviate from historical standards.

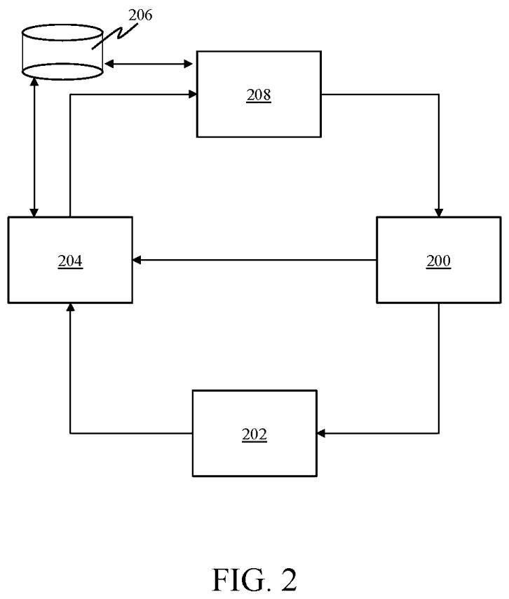

FIG. 2 is a schematic illustration of an implementation scenario of different modules employed by a processing unit (not shown), in accordance with an embodiment of the present disclosure. As shown, a simulation model 200 is used to generate simulation data related to an industrial operation. The simulation model 200 may comprise of a forward simulator, an optimizer or a rule-based decision making logic. Moreover, a knowledge graph ontology builder module 202 is used to generate a knowledge graph ontology, based on a domain of the industrial operation. Furthermore, the knowledge graph creation module 204 is used to generate a knowledge graph instance representing the simulation data, based on the generated knowledge graph ontology. Furthermore, the generated knowledge graph ontology and the generated knowledge graph instance are stored in a database 206 communicably coupled to the processing unit. Furthermore, a simulation assistant 208 is used to analyze the quality of the industrial operation via the simulation data represented in the knowledge graph instance and generate a response to a user request. Furthermore, recommendations approved by the user for the simulation data are sent from the simulation assistant 208 to the simulation model 200 to generate updated simulation data.

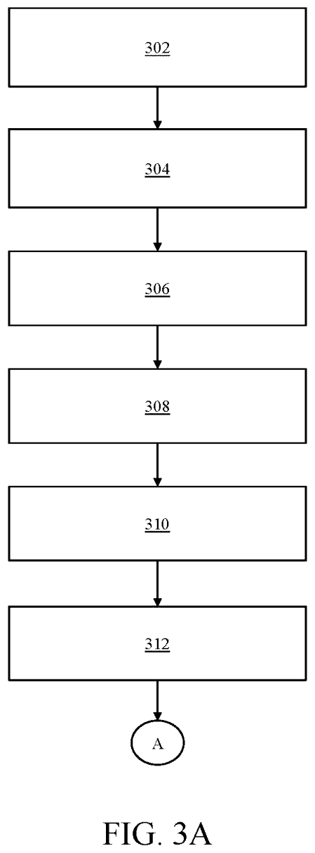

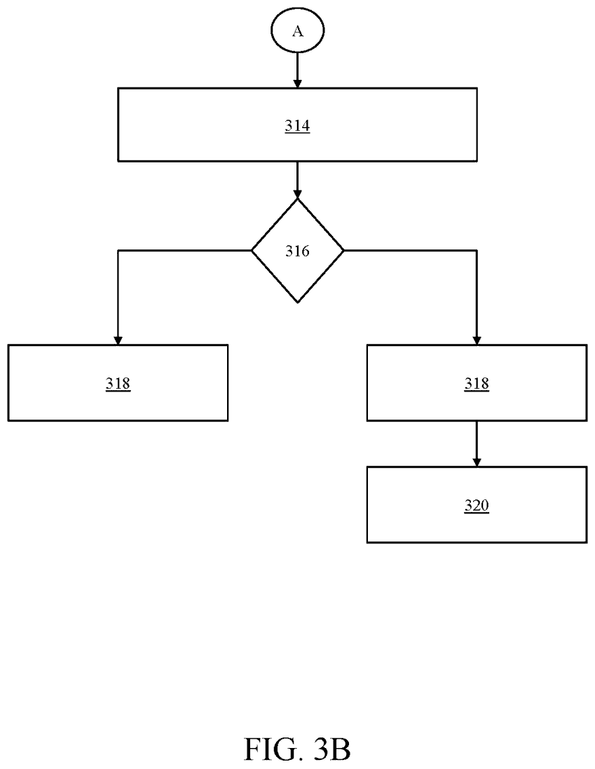

FIGS. 3A and 3B collectively are a flowchart for depicting steps of a method for optimization of an industrial operation, based on simulation data thereof, in accordance with an embodiment of the present disclosure. At step 302, the simulation data related to the industrial operation is generated, using a Discrete Event Simulation (DES) model. At step 304, a knowledge graph ontology is generated, based on a domain of the industrial operation, using a knowledge graph ontology builder module. At step 306, a knowledge graph instance representing the simulation data is generated, based on the knowledge graph ontology, using a knowledge graph creation module. At step 308, a user request to analyze a quality of the industrial operation via the simulation data represented in the knowledge graph instance, is received from a user device of a user communicably coupled to the processing unit. At step 310, the quality of the industrial operation is analyzed via the simulation data represented in the knowledge graph instance using a simulation assistant. At step 312, a response to the user request is generated, using a simulation assistant, based on the analysis of the quality of the industrial operation. At step 314, the response is sent to the user device. At step 316, a first user input is received from the user device, wherein the first user input is indicative of a user approval on the industrial operation, based on the response, and when the user approval on the industrial operation is positive, at step 318, the simulation data for implementation of the industrial operation is employed, or when the user approval on the industrial operation is negative, at step 318, an updated simulation data is generated, based on the analysis of the quality of the industrial operation, and at step 320, steps from generating the knowledge graph instance to receiving the first user input are repeated, for the updated simulation data, wherein the quality of the industrial operation is analyzed via the updated simulation data represented in an updated knowledge graph instance using the simulation assistant, based on a comparison of the updated knowledge graph instance representing the updated simulation data with previously stored knowledge graph instances of historical data related to the industrial operation, stored in a database.

Modifications to embodiments of the present disclosure described in the foregoing are possible without departing from the scope of the present disclosure as defined by the accompanying claims. Expressions such as “including”, “comprising”, “incorporating”, “have”, “is” used to describe, and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other described embodiment of the disclosure.

What is claimed is:

1. A system (100) for optimization of an industrial operation, based on simulation data thereof, the system comprising:
a processing unit (102) configured to:
(i) generate the simulation data related to the industrial operation;
(ii) generate a knowledge graph ontology, based on a domain of the industrial operation, using a knowledge graph ontology builder module;
(iii) generate a knowledge graph instance representing the simulation data, based on the knowledge graph ontology, using a knowledge graph creation module;
(iv) receive a user request to analyze a quality of the industrial operation via the simulation data represented in the knowledge graph instance, from a user device (104) of a user communicably coupled to the processing unit;
(v) analyze the quality of the industrial operation via the simulation data represented in the knowledge graph instance using a simulation assistant;
(vi) generate a response to the user request, using the simulation assistant, based on the analysis of the quality of the industrial operation;
(vii) send the response to the user device;
(viii) receive a first user input from the user device, wherein the first user input is indicative of a user approval on the industrial operation, based on the response; and
when the user approval on the industrial operation is positive:
(ix) employ the simulation data for implementation of the industrial operation; or
when the user approval on the industrial operation is negative:
(ix) generate an updated simulation data, based on the analysis of the quality of the industrial operation, and
(x) repeat steps (iii) to (viii) for the updated simulation data, wherein the quality of the industrial operation is analyzed via the updated simulation data represented in an updated knowledge graph instance using the simulation assistant, based on a comparison of the updated knowledge graph instance representing the updated simulation data with previously stored knowledge graph instances of historical data related to the industrial operation, stored in a database communicably coupled to the processing unit.

2. The system (100) of claim 1, wherein the processing unit (102) is further configured to:
receive a second user input from the user device (104), via a Language Learning Model (LLM) assistant, wherein the second user input is indicative of an efficacy of the knowledge graph ontology that is generated;
compare the efficacy of the knowledge graph ontology with a predefined threshold value; and
when the efficacy of the knowledge graph ontology is lower than the predefined threshold value, modify the knowledge graph ontology, based on a second user input received from the user device.

3. The system (100) of claim 1, wherein the knowledge graph ontology comprises:
nodes and relationships of interest of the industrial operation, extracted from the domain of the industrial operation and simulation data.

4. The system (100) of claim 1, wherein the analysis of the quality of the industrial operation comprises: inefficiencies in the industrial operation, root cause of the inefficiencies, insights or recommendations based on the inefficiencies and user inputs.

5. A method for optimization of an industrial operation, based on simulation data thereof, the method comprising:
(i) generating the simulation data related to the industrial operation;
(ii) generating a knowledge graph ontology, based on a domain of the industrial operation, using a knowledge graph ontology builder module;
(iii) generating a knowledge graph instance representing the simulation data, based on the knowledge graph ontology, using a knowledge graph creation module;
(iv) receiving a user request to analyze a quality of the industrial operation via the simulation data represented in the knowledge graph instance, from a user device (104) of a user communicably coupled to the processing unit;
(v) analyzing the quality of the industrial operation via the simulation data represented in the knowledge graph instance using a simulation assistant;
(vi) generating a response to the user request, using the simulation assistant, based on the analysis of the quality of the industrial operation;
(vii) sending the response to the user device;
(viii) receiving a first user input from the user device, wherein the first user input is indicative of a user approval on the industrial operation, based on the response; and
when the user approval on the industrial operation is positive:
(ix) employing the simulation data for implementation of the industrial operation; or
when the user approval on the industrial operation is negative:
(ix) generating an updated simulation data, based on the analysis of the quality of the industrial operation, and
(x) repeating steps (iii) to (viii) for the updated simulation data, wherein the quality of the industrial operation is analyzed via the updated simulation data represented in an updated knowledge graph instance using the simulation assistant, based on a comparison of the updated knowledge graph instance representing the updated simulation data with previously stored knowledge graph instances of historical data related to the industrial operation, stored in a database.

6. The method of claim 5, further comprising:
receiving a second user input from the user device (104), via a Language Learning Model (LLM) assistant, wherein the second user input is indicative of an efficacy of the knowledge graph ontology that is generated;
comparing the efficacy of the knowledge graph ontology with a predefined threshold value; and
when the efficacy of the knowledge graph ontology is lower than the predefined threshold value, modifying the knowledge graph ontology, based on a second user input received from the user device.

7. The method of claim 5, wherein the knowledge graph ontology comprises: nodes and relationships of interest in the industrial operation, extracted from the domain of the industrial operation and simulation data.

8. The method of claim 5, wherein the analysis of the quality of the industrial operation comprises: inefficiencies in the industrial operation, root cause of the inefficiencies, insights or recommendations based on the inefficiencies and user inputs.
